(19) United States
(12) Patent Application Publication
(10) Pub. No.: US 2017/0139723 A1
(43) Pub. Date: May 18, 2017

(54) USER EXPERIENCE MAPPING IN A GRAPHICAL USER INTERFACE ENVIRONMENT

(71) Applicant: UX-FLO, Inc., Norco, CA (US)

(72) Inventors: John Graham Holland, Norco, CA (US); Alexey Zerkalenkov, Adelshofen (DE)

(21) Appl. No.: 15/349,473

(22) Filed: Nov. 11, 2016

Related U.S. Application Data
(60) Provisional application No. 62/255,367, filed on Nov. 13, 2015.

(51) Int. Cl. G06F 9/44; G06F 3/0481

(52) U.S. Cl. CPC G06F 9/4443; G06F 3/0481; G06F 3/04883

(57) ABSTRACT

A method is disclosed that includes recording data of a plurality of interactions with a graphical user interface (GUI) environment by a user as the user executes one or more operations in the GUI environment. An interaction may include movement between sequential input events in the GUI environment caused by the user. A graphical representation of the recorded data of the plurality of interactions may be generated. The graphical representation may include movement between at least two sequential input events. The graphical representation may be displayed in combination with (e.g., overlayed on) the GUI environment on a computer processor display. The graphical representation may include a map that depicts sequential movement between two or more input events and a linear timeline of the movement between the input events caused by the user.

### PRIORITY CLAIM

This patent claims priority to U.S. Provisional Patent Application No. 62/255,367 to Holland et al. filed Nov. 13, 2016, which is incorporated by reference in its entirety as if fully set forth herein.

### BACKGROUND OF THE INVENTION

1. Field of the Invention

Embodiments disclosed herein relate to the tracking of software usage in a GUI (graphical user interface) environment. Certain embodiments relate to systems and methods for recording software usage in the GUI environment and graphically displaying the recording of software usage.

2. Description of the Relevant Art

Software usage and tracking analytics are frequently used to understand information about user interactions with software such as websites or other interactive user environments. Vertical event tracking (or event to event tracking) is often used to track website fall-off points, or other software usage. Vertical event tracking, however, is limited to tracking when an isolated event happens (e.g., when a user enters or leaves a web page or website). For example, Google Analytics™ (Google, Inc., Mountain View, Calif.) is used to track website usage including when users enter or leave a website.

Video recording of a user's interaction with a website or other software may be used to record a user's movements (e.g., cursor movement) and/or visual changes in the software as the user navigates the interactive environment. Video recording, however, only provides a direct playback of what was seen on a display of the interactive environment. Additionally, video recording typically only shows the present interaction on the display as the interaction is happening in that moment in (recorded) time without any display of past or future interactions from the recording. Direct comparison of two user's software interactions may also be difficult using video recording. Each user would have his/her own video recording associated with their usage session involving the software. Comparison of the video recordings may only be done using side-by-side comparison or playing back one recording after the other. There is no simple method to directly compare the video recordings on top of each other.

What, how, and/or why the user interacts with a website or other interactive software in a certain manner or purpose, however, is not easily accessible using vertical event tracking and/or video recording. Thus, there is a need for systems and methods to track or record a user's actual horizontal interaction path within a website or other interactive software to understand the user's behavior. Understanding the user's “horizontal” interaction behavior may include being able to display the user's sequential interaction for analysis of the interaction and/or providing comparative analysis of the user's interaction. Additionally, it may be useful to record multiple users' interactions with a website (or other interactive software) and display the recorded interactions simultaneously to develop a better understanding of how the website is working based on certain user characteristics and usage flow.

### SUMMARY OF THE INVENTION

In certain embodiments, a method includes recording, using a computer processor, data of a plurality of interactions with a graphical user interface (GUI) environment by a user as the user executes one or more operations in the GUI environment. At least one of the interactions may include movement between at least two sequential input events in the GUI environment caused by the user. A graphical representation of the recorded data of the plurality of interactions may be generated by the computer processor. The graphical representation may include movement between the at least two sequential input events caused by the user. The graphical representation may be displayed in combination with the GUI environment on a display coupled to the computer processor.

In certain embodiments, a method includes providing, using a computer processor, a plurality of operations to be executed by a plurality of users in a graphical user interface (GUI) environment. The computer processor may record data of a plurality of interactions with the GUI environment by each user as the user executes one or more operations in the GUI environment. At least one of the interactions may include movement between at least two sequential input events in the GUI environment, the movement being in response to input by the user. The recorded data of plurality of interactions for at least two users may be combined. The computer processor may generate a graphical representation of the combined data. The graphical representation may include sequential movement between at least two input events based on the combined data. The graphical representation may be displayed in combination with the GUI environment on a display coupled to the computer processor.

In certain embodiments, a non-transient computer-readable medium including instructions that, when executed by one or more processors, causes the one or more processors to perform a method that includes recording, using a computer processor, data of a plurality of interactions with a graphical user interface (GUI) environment by a user as the user executes one or more operations in the GUI environment. At least one of the interactions may include movement between at least two sequential input events in the GUI environment caused by the user. A graphical representation of the recorded data of movement of the plurality of interactions may be generated by the computer processor. The graphical representation may include the movement between the at least two sequential input events caused by the user. The graphical representation may be displayed in combination with the GUI environment on a display coupled to the computer processor.

### BRIEF DESCRIPTION OF THE DRAWINGS

Features and advantages of the methods and apparatus described herein will be more fully appreciated by reference to the following detailed description of presently preferred but nonetheless illustrative embodiments when taken in conjunction with the accompanying drawings in which:

FIG. 1 depicts a flowchart of an embodiment for assessing a user's experience with a graphical user interface (GUI) environment.

FIG. 2 depicts a representation of an embodiment of a GUI environment.

FIG. 3 depicts a representation of an embodiment of a graphical representation in combination with a GUI environment.

FIG. 4 depicts a representation of embodiments of different symbols for different input events.

FIG. 5 depicts a flowchart of an embodiment of a replay (playback) session.

FIG. 6 depicts a representation of an embodiment of a graphical representation with multiple layers.

FIG. 7 depicts a block diagram of one embodiment of an exemplary computer system.

FIG. 8 depicts a block diagram of one embodiment of a computer accessible storage medium.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to. Additionally, as used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

The following examples are included to demonstrate preferred embodiments. It should be appreciated by those of skill in the art that the techniques disclosed in the examples which follow represent techniques discovered by the inventor to function well in the practice of the disclosed embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosed embodiments.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

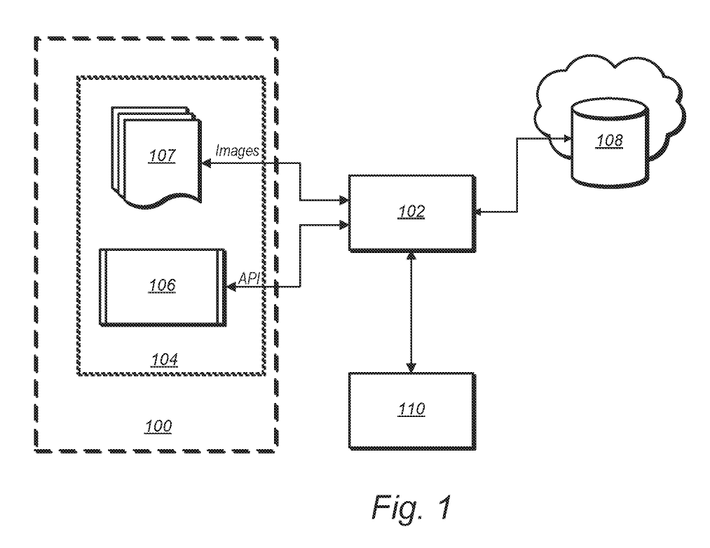

FIG. 1 depicts a flowchart of an embodiment for assessing a user's experience with a graphical user interface (GUI) environment. In certain embodiments, data recording module 102 is coupled to GUI environment 104. Data recording module 102 may be an API (application program interface), an embedded module, or other interface that records user interactions with GUI environment 104 as described herein. GUI environment 104 may be a GUI associated with software application 106. Examples of software application 106 include, but are not limited to, a website application, a mobile application (e.g., a mobile app), or another user interactive application. Software application 106 may drive or function to operate GUI environment 104.

In some embodiments, GUI environment 104 and software application 106 are associated with computer processor 100. For example, GUI environment 104 may operate using display 107 (e.g., a monitor) of computer processor 100. Software application 106 may be stored in a memory of computer processor 100. In some embodiments, data recording module 102 is located on computer processor 100 (e.g., stored in the memory of the computer processor). In some embodiments, data recording module 102 accesses computer processor 100, along with GUI environment 104 and software application 106, from another location. For example, data recording module 102 may be linked to GUI environment 104 and software application 106 on computer processor 100 through a network (e.g., the Internet).

A user and/or a plurality of users may interact with GUI environment 104 to execute operations associated with software application 106. In certain embodiments, the user, or users, interact with GUI environment 104 in an unstructured format. The unstructured format may be, for example, simple, general interaction between a user, or users, and a web page or another software application without any restrictions, defined steps/tasks, or defined guidelines placed on the interaction. In some embodiments, data from unstructured format interactions is continuously recorded as the usages occur. Any new recorded data is added to the database of interaction data as described herein.

In some embodiments, a user, or users, interact with GUI environment 104 in a structured format. In the structured format, the user, or users, may be provided with a set of steps/tasks (e.g., operations) to complete while interacting with GUI environment 104. The operations may be predefined for the user by, for example, an administrator or developer of software application 106. An example of a set of predefined steps/tasks may be operations taken to purchase a selected product with selected options from a website. Predefining the user's operations may allow specific characteristics of software application 106 to be analyzed and/or refined.

In certain embodiments, data recording module 102 records data associated with actions made by the user in GUI environment 104 as the user executes one or more operations associated with software application 106. The operations executed may be in either the structured format and/or the unstructured format. In some embodiments, data recording module 102 includes an application (or other interface) that runs GUI environment 104 within the application. For example, data recording module 102 may be linked to software application 106 to run GUI environment within the data recording module. Actions that may be made by the user include, but are not limited to, the user moving a cursor or other position indicator within GUI environment 104 and/or input events executed by the user (e.g., actions made by the user with the position indicator at a selected position in the GUI environment).

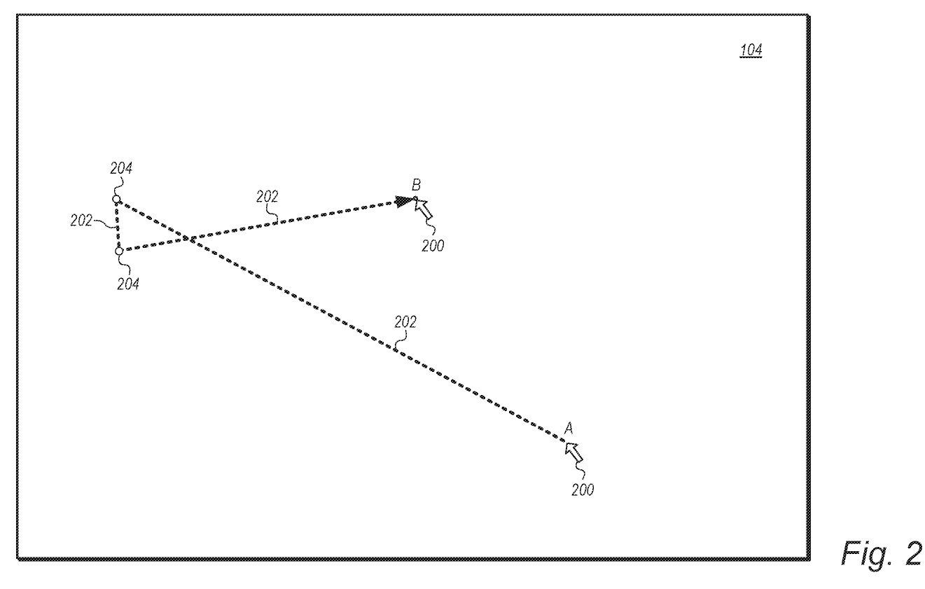

FIG. 2 depicts a representation of an embodiment of GUI environment 104. In one embodiment, GUI environment 104 is a web page or another software GUI. In certain embodiments, indicator 200 is an indicator or a symbol used within GUI environment 104 that identifies a selected position within the GUI environment. In some embodiments, indicator 200 identifies a selected position in GUI environment 104 that will be affected by input from the user. Indicator 200 may be, for example, a cursor arrow, as shown in FIG. 2, or another symbol that identifies a position within GUI environment 104. Indicator 200 may be moved between different locations in GUI environment 104 through actions by the user and/or in response to actions by the user. Movement lines 202 may indicate movement of indicator 200 within GUI environment 104. For example, indicator 200 may be moved from point A to point B along movement lines 202, as shown in FIG. 2.

Indicator 200 may be moved in GUI environment using any input device known in the art. For example, indicator 200 may be moved using input devices including, but not limited to, a mouse, a finger (e.g., for a touchscreen display), a stylus, a trackpad, eye movement, voice input, and/or a keyboard. In some embodiments, indicator 200 is a “virtual indicator” that is not displayed in GUI environment 104 but is still used to identify position in the GUI environment. For example, indicator 200 may include touches or taps on a touchscreen (e.g., a mobile device touchscreen) that define points (e.g., endpoints) of movement on the touchscreen. As a further example, the user may touch a first point on the touchscreen and then touch another point on the touchscreen to indicate movement of the “virtual indicator”. Movement line 202 may then be an interpolation between the two touch points on the touchscreen with the movement line indicating movement of the “virtual indicator” (e.g., indicator 200).

In some embodiments, one or more input events 204 occur at one or more points along movement lines 202 for indicator 200. In some embodiments, input events 204 are triggered by the input device used to move indicator 200 along movement lines 202. Input event 204 may include a user action that directs software application 106 to do something in response to the user action (e.g., an interactive event). For example, input event 204 may include, but not be limited to, a mouse event (e.g., a mouse click, a mouse rollover, a mouse wheel scroll, or a mouse drag), a touch event (e.g., a finger touch on a touchscreen), a voice event, or any other user input that directs action by software application 106 (e.g., drives user interaction with the software application). One example of input event 204 includes an action that directs software application 106 to move from one page to another page on a website driven by the software application. It is to be understood that while indicator 200 and input events 204 are described herein within the context of a two-dimensional (2D) GUI environment that, in some embodiments, it may also be contemplated that indicator 200 and/or input events 204 may be associated with interactions in a three-dimensional (3D) GUI environment. For example, indicator 200 (and movement associated with the indicator) and/or input events 204 may be associated with interactions in a virtual reality 3D GUI environment. As with the 2D GUI environment interactions described herein, the 3D GUI environment interactions may be recorded and used to generate a graphical representation of the recorded interactions displayed in combination with the 3D GUI environment.

In certain embodiments, data recording module 102, shown in FIG. 1, records movement of indicator 200 and input events 204 sequentially as the movement and events occur (e.g., the module records indicator movement and input events as a function of time). Thus, data recording module 102 may record sequential usage events or a workflow pattern for user interaction with GUI environment 104 and software application 106. In some embodiments, data recording module 102 records data for a usage session. A usage session may be, for example, a time period a user interacts with GUI environment 104 and software application 106 (e.g., a selected period of time the user interacts with the GUI environment and the software application). In some embodiments, the usage session is defined by a stuctured number and/or path of steps to be executed by the user (e.g., a number of steps to get from a predetermined beginning point to a predetermined end point). In other embodiments, the usage session may be defined by getting from the predetermined beginning point to the predetermined end point regardless of the number and/or path of steps.

Recording indicator movement and input events sequentially may include, for example, recording movement of the indicator (e.g., cursor) between input events driven by a mouse (e.g., recording user controlled movement of the indicator between mouse clicks). In some embodiments, recording indicator movement and input events includes recording images from display 107 (associated with GUI environment 104) as data in addition to recording indicator movement and input events as the user moves through the workflow associated with software application 106. Images from display 107 may be, for example, screen snapshots or screen captures. For example, screen snapshots from display 107 may be recorded when input events occur. Recording only indicator movement and input events (e.g., the workflow pattern) along with screen snapshots provides data recording without the need for data recording module 102 to be embedded in software application 106 and/or without the need for an API integrated with the software application. Such data recording may be useful for applications where access to software application 106 is not readily available (e.g., analysis of a competitor software application).

In some embodiments, data recording module 102 records functions triggered by indicator movement and/or input events (e.g., the data recording module records functional interactions). For example, data recording module 102 may record functions executed by software application 106 that are triggered by indicator movement and/or input events initiated by the user. Recording functional interactions may require embedded code in software application 106 or an API integrated with the software application associated with data recording module 102. In some embodiments, the embedded code or the integrated API in software application 106 is a simple code that provides functional interaction data to data recording module 102.

In some embodiments, data recording module 102 is provided additional access to software application 106 through embedded code and/or an integrated API in the software application. The additional access provided to data recording module 102 may include operational access to software application 106. Providing operational access to data recording module 102 may include recording the association of specific functions within software application 106 itself. Providing this operational access to data recording module 102 may allow the data recording module to trigger events in software application 106 (and GUI environment 104) and/or drive functions in the software application. For example, data recording module 102 may be able to drive operation of software application 106 using data stored in database 108 (e.g., recorded data), as described herein.

In certain embodiments, the data recorded by data recording module 102 (e.g., the usage data associated with actions made by the user in GUI environment 104) is provided to database 108. In some embodiments, database 108 is located on a computer processor associated with data recording module 102 (e.g., the database is in the memory of the computer processor also storing the data recording module). Database 108 may, however, be located on a computer processor remotely coupled (e.g., networked) to data recording module 102. For example, database 108 may be located in a computing cloud.

The data recorded by data recording module 102 may be used to generate graphical representation 110, as shown in FIG. 1. In some embodiments, data recording module 102 generates graphical representation 110 directly from the recorded data (e.g., the graphical representation is generated as the data is recorded). In some embodiments, data recording module 102 generates graphical representation 110 after retreiving recorded data from database 108. Graphical representation 110 may provide a representation of the recorded data for a usage session for a user. In some embodiments, graphical representation 110 provides a representation of an aggregate of recorded data for multiple usage sessions for one or more users as described herein.

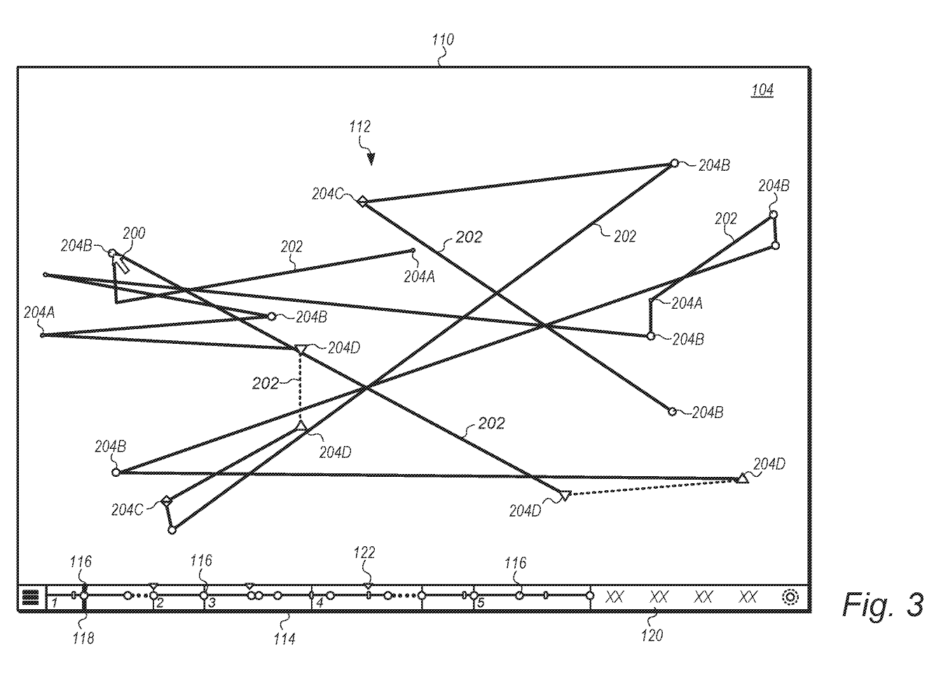

FIG. 3 depicts a representation of an embodiment of graphical representation 110. In certain embodiments, graphical representation 110 of sequential recorded events is displayed in combination with GUI environment 104. For example, graphical representation 110 may be overlayed or displayed on top of GUI environment 104 such that the graphical representation displays the recorded data in the same context as the data was recorded—in the context of GUI environment 104 associated with software application 106.

In some embodiments, graphical representation 110 is displayed on the same display used to interact with GUI environment 104. For example, graphical representation 110 may be displayed on a display used by the user after the usage session has ended. In some embodiments, graphical representation 110 is displayed on a different display. For example, graphical representation 110 may be displayed on a display used by another user (e.g., a software administrator or software designer) at a separate location from the initial user.

In certain embodiments, graphical representation 110 includes map 112. Map 112 may be a graphical usage map, or a graphical display of paths, that charts usage of software application 106 over time as recorded in one or more usage sessions by data recording module 102. In certain embodiments, map 112 includes input events 204 and movement lines 202. Movement lines 202 show the user's sequential usage path (e.g., indicator movement) between input events 204. Movement lines 202 are shown as straight lines between sequential input events 204 in FIG. 3. It is to be understood that movement between sequential input events 204 may, however, not occur in a straight line (e.g., the user may not go straight between sequential input events). Nevertheless, movement between sequential input events 204 may be shown by straight movement lines 202 as the data between the sequential input events (e.g., how the user moved the indicator (cursor) from one input event to the next input event) may be less critical for analysis. In some embodiments, however, data for exact movement of the indicator may be recorded and used to generate movement lines 202.

Input events 204 and movement lines 202 shown in FIG. 3 are representations (e.g., recorded representations or simulated representations) of the input events and indicator movement lines shown in FIG. 2. As map 112 is placed on top of GUI environment 104, input events 204 and movement lines 202 are shown in the context of the user's interaction with the GUI environment (e.g., the locations of the input events and the movement lines shown in FIG. 3 are substantially similar to where they occur during the recorded usage session and/or the input events are associated with the functions of the specific GUI objects that the input events represent).

In certain embodiments, different symbols are used to describe different input events 204. Examples of input events 204 that may be depicted in map 112, shown in FIG. 3, include but are not limited to, mouse events, touch events, and any other type of physical or virtual user input that triggers a function in the software. Mouse events may include mouse button clicks, double clicks, mouse wheel or scroll, drag, or rollover states. Touch events may include tap, double tap, long tap, tap drag, etc. In some embodiments, the same symbols may be used for equivalent function input events using different input devices. For example, the same symbol may be used for a mouse click event as a touch tap event.

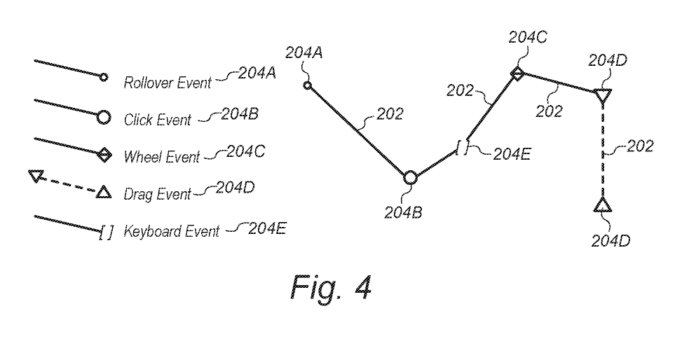

FIG. 4 depicts a representation of embodiments of different symbols for different input events 204. In one embodiment, input events 204A are rollover events, input events 204B are click events, input events 204C are wheel (scroll) events, and input events 204D are drag events. A drag event may also be symbolized using dashed lines for a movement line between end points of the drag event, as shown in FIGS. 3 and 4.

In certain embodiments, as shown in FIG. 3, graphical representation 110 includes timeline 114. Timeline 114 may be a bar graph or linear graph depicting a linear timeline of events for the usage session depicted in graphical representation 110. Timeline 114 may provide an accurate depiction of time for the usage session (or aggregate of usage sessions) depicted in graphical representation 110. For example, timeline 114 may depict events along a timeline from the beginning of the usage session to the end of the usage session. Circles 116 along timeline 114 indicate events along the timeline. Events indicated by circles 116 in timeline 114 may symmetrically (in time) correspond to input events 204 depicted in map 112. Thus, timeline 114 provides a linear depiction of events (circles 116) that is symmetrical to input events 204 depicted in map 112.

In certain embodiments, graphical representation 110 provides playback of the usage session (or the aggregate of usage sessions). For example, graphical representation 110 may provide playback from the beginning of the usage session to the end of the usage session. In certain embodiments, playback of the usage session includes sequential playback between events. Frames in the playback may correspond to events along timeline 114. Thus, the user experiences event to event transitions in map 112 as the playback of the usage session progresses through timeline 114.

Playback of the usage session (or a portion of the usage session) may occur symmetrically between map 112 and timeline 114. Bar 118 in timeline 114 may indicate a time position (e.g., a current event position) during playback along the timeline while cursor 120 in map 112 indicates the current event position in the map at the time position shown by the bar in the timeline. Cursor 120 may move along movement lines 202 and between input events 204 as playback occurs. Bar 118 in timeline 114 may move symmetrically with cursor 120. For example, as shown in FIG. 3, the position of cursor 120 in map 112 is symmetric in time with the position of bar 118 along timeline 114 and both the cursor and the bar at positioned at the same event.

Playback of the usage session may be controlled similar to a movie player. For example, start, pause, stop, rewind, fast forward, and other controls may be used during playback of the usage session. Additionally, one or more controls may be used to navigate to different points of the playback of the usage session. In certain embodiments, timeline 114 is used to navigate to different points in time of the playback of the usage session depicted in graphical representation 110. For example, clicking or tapping on a point (or event) along timeline 114 may move both bar 118 and cursor 120 to the same point in time (e.g., the same event) in the playback of the usage session. Thus, clicking or tapping on timeline 114 may provide symmetric navigation through the playback of the usage session. Alternatively, clicking or tapping on a position in map 112 may move cursor 120 to the position in the map and bar 118 may correspondingly move to the symmetrical position along timeline 114.

In some embodiments, playback is limited to a portion of the usage session. For example, a specific portion of timeline 114 may be selected (e.g., bracketed) by the user so that only the specific portion of the usage session is replayed during the playback. The specific portion may be a selected range in timeline 114. As the playback is a sequential playback between events, selecting the range may be limited to selecting a range between events (notated by circles 116) in timeline 114.

In some embodiments, specific event information is provided for individual events in graphical representation 110. For example, a user may provide a rollover action (or another highlight operation) over input events 204 and/or circles 116 (that indicate events on timeline 114) on graphical representation 110. A pop-up label or another information window with specific event information may be provided in response to the rollover action. The specific event information may include, for example, event type, event time, and/or functional interactions associated with the event.

In certain embodiments, functional interactions recorded using embedded code in software application 106 or an API integrated with the software application (e.g., functions of the software application triggered by user input) are used by data recording module 102 to generate graphical representation 110. The embedded code or the integrated API may allow data recording module 102 to drive operation of software application 106 based on the recorded data. The playback of the usage session (or an aggregate of usage sessions) in graphical representation 110 thus includes execution of GUI environment 104 by software application 106 according to the recorded data. The playback in graphical representation 110 generated by data recording module 102 using recorded functional interactions is substantially a replay of the usage session using software application 106, and input of functional interactions into the software application, to control operation of the graphical representation displayed in combination with GUI environment 104.

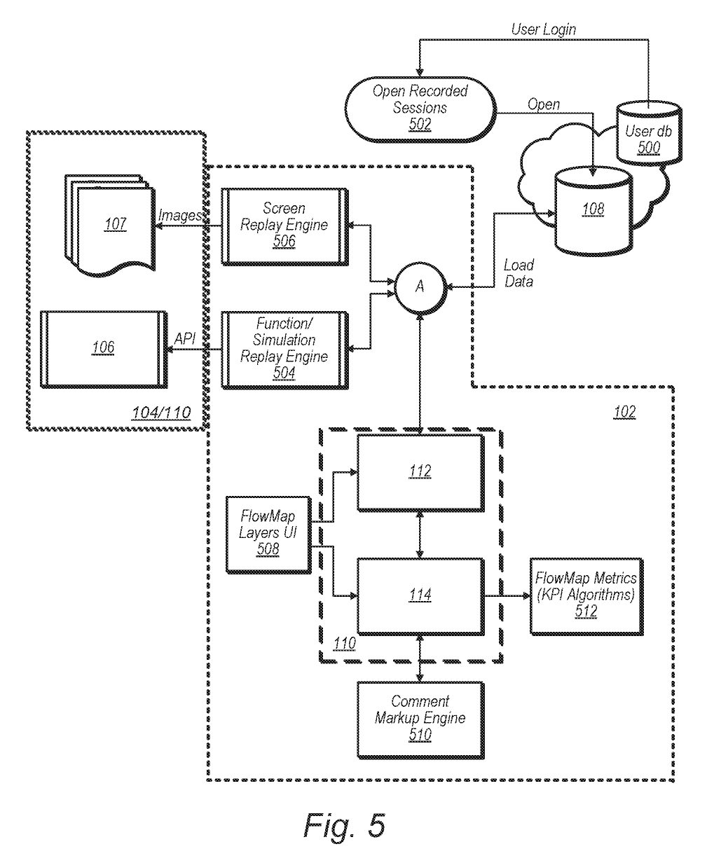

FIG. 5 depicts a flowchart of an embodiment of a replay (playback) session using data recording module 102. Data recording module 102 may retrieve data from database 108. In some embodiments, data recording module 102 retrieves data in response to a user login (with the identity of the user being found in user database 500) and an open recorded session request 502. After data recording module 102 retrieves (loads) data from database 108, the data recording module may generate map 112 and timeline 114. Generating map 112 and timeline 114 may include generating user interface information. Function/simulation replay engine 504 may use the user interface information for map 112 and timeline 114 to generate graphical representation 110 and drive live replay (playback) of software application 106 in GUI environment 104 through the integrated API (or embedded code in the software application), or through robotic interaction with the GUI environment itself. In some embodiments, when replaying a non-embedded session recording, images (e.g., screen captures or snapshots) may be displayed on display 107 to replace the live driving of software application 106. In such embodiments, screen replay engine 506 may use the user interface information for map 112 and timeline 114 to generate graphical representation 110 with the screen snapshots to be displayed in combination with GUI environment 104.

In some embodiments, a user may provide user-sourced additions to graphical representation 110 using comment markup engine 510. Additions (shown as additions 122 in FIG. 3) may include, but not be limited to, adding bookmarks to timeline 114, adding comments to the timeline, attaching documents to the timeline, and sharing links (e g , hyperlinks) on the timeline. In certain embodiments, these additions are added to events (e.g., circles 116) along timeline 114. The additions may be used to draw attention to points of attention for other users (similar to comments in PDF files).

In certain embodiments, data recording module 102 may generate metrics for one or more of the usage sessions using map metrics engine 512. The metrics may be useful for statistical analysis of the usage sessions. Generating metrics may include assessment of usage data from the recorded usage sessions and scoring or rating the data based on certain analytics. One metric that may be generated is a Power KPI (Key Performance Indicator). Power KPI may be used to compare the amount of work done over time. Power KPI may be defined as: (Events/Distance)×Time=Power. Power KPI may be used to provide a comparative for A/B task based session testing. A/B task based session testing may be used to compare different versions (A vs B) of a web page or another software application.

Another useful metric for statistical analysis that may be generated is an Efficiency KPI. Efficiency KPI may be defined as: (ΔEvents/ΔDistance)/ΔTime=EPS (Effective Events per Second). EPS may be an application independent metric (e.g., a metric normalized between different applications). EPS may be used to compare different applications (e.g., different software applications). EPS may provide a comparison of overall performance for different software applications. Thus, EPS may provide an overall software application rating system that allows software applications to be benchmarked against each other based on big data workflow aggregation. EPS may be used, for example, as to identify unforeseen patterns of usage (e.g., if efficiency is comparatively low). Other big data metrics may also be contemplated that provide unstructured or freeform ways to filter data regardless of the software application and allow users to compare different user experiences.

In some embodiments, the generated metrics may be filtered and/or searched through using artificial intelligence (AI) engines (e.g., computer processor based machine learning). The AI engines may learn to identify patterns and/or usage anomalies in software applications. In some embodiments, the generated metrics are displayed in session metrics dashboard 120 in graphical representation 110, shown in FIG. 3.

In some embodiments, data recording module 102 may record data associated with actions made by multiple users in GUI environment 104 as the users execute one or more operations associated with software application 106, as shown in FIG. 1. The recorded data for the multiple users may include data recorded in individual usage sessions for each user (e.g., each user has his/her own usage session recorded separately). The individual usage sessions may be recorded and stored in database 108.

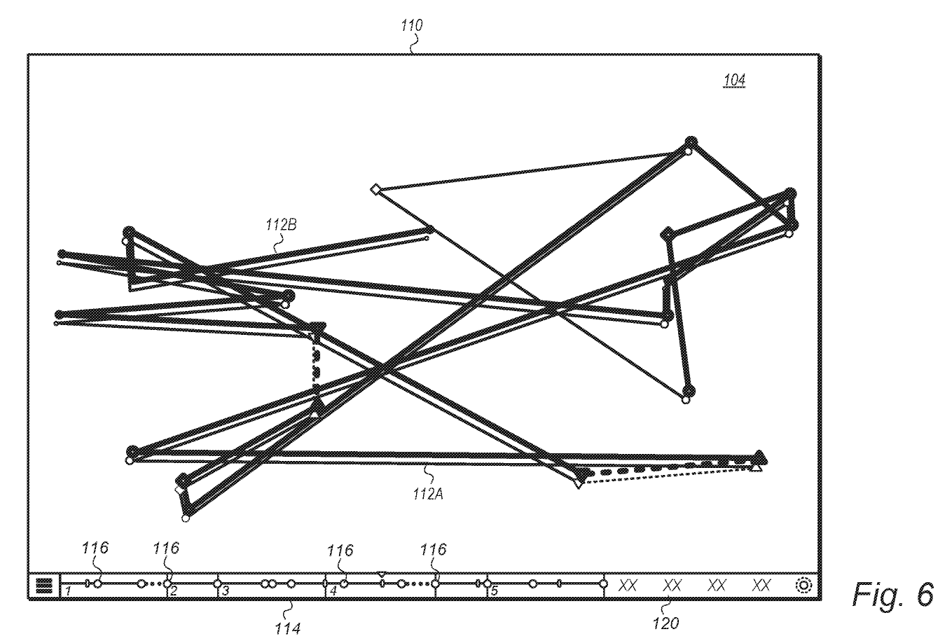

In some embodiments, data recording module 102 generates and aggregates multiple graphical presentation layers in 508, as shown in FIG. 5. The multiple graphical presentation layers may include multiple maps 112 and multiple timelines 114 with each map and each timeline corresponding to an individual recorded usage session. Screen replay engine 506 may then provide the multiple graphical presentation layers to graphical presentation 110 to be displayed in combination with GUI environment 104. FIG. 6 depicts a representation of an embodiment of graphical representation 110 with multiple layers. Graphical representation 110 may display the multiple layers as multiple overlays of map 112 and/or timeline 114 in combination with GUI environment 104.

To allow a user to compare and contrast the different usage sessions represented by the multiple layers, the multiple layers may be differentiated using different identification characteristics displayed in graphical representation 110. For example, the layers may be color coded and/or be named. As shown in FIG. 6, different line weights are used to differentiate map 112A (lighter line weight) from map 112B (heavier line weight). Additionally, different layers may be made invisible or transparent as needed (e.g., by clicking on a name in a legend). In some embodiments, only one timeline 114 for one layer is visible at a time in graphical representation 110. Displaying only one “active” timeline 114 may provide less confusion in graphical representation 110. When only one timeline 114 is displayed at a time, the active timeline may be selected by the user (e.g., by clicking on the name in the legend).

Providing multiple layers of maps 112 in graphical representation 110 may allow a user to more easily compare and contrast different usage sessions. Providing overlays of maps 112 in graphical representation 110 may provide unobscured view of two or more map layers so that the sequential usage paths for each layer (e.g., each usage session) may be seen on the same page. For example, as shown in FIG. 6, the sequential usage path in map 112B diverges from the sequential usage path in map 112A for a portion of the usage session. Placing the layers on the same page allows a user to more readily assess divergence between the different sequential usage paths. Comparing and contrasting different usage sessions may allow the user to more readily: assess convergent and/or divergent behaviors associated with GUI environment 104, assess usage patterns, diagnose usability flaws of the GUI environment, and develop design insights for the GUI environment.

Because data recording module 102 may drive operation of software application 106 in association with generating graphical presentation 110, aggregate session data may be used to drive the software application and generate the graphical presentation. In certain embodiments, recorded data from multiple usage sessions is aggregated (e.g., combined or compiled) into an aggregate data set. The aggregate data set may be used as a single set of data for data recording module 102 to generate map 112 and timeline 114 along with user interface information for the map and the timeline. Function/simulation replay engine 504 may use the user interface information for the aggregate data set to drive software application 106 through the integrated API. Screen replay engine 506 may use the interface information for the aggregate data set to generate graphical representation 110 to be displayed in combination with GUI environment 104. Thus, map 112 and timeline 114 displayed in graphical representation 110 symmetrically represent a single usage session for the aggregate data set.

The aggregate data set may be an aggregate of recorded session data with selected criteria. The selected criteria may be criteria based on one or more characteristics of the user and/or characteristics of the usage session. For example, in some embodiments, the aggregate data set may be a collection of session data for users in certain demographics (e.g., gender, age range, ethnic background, geographic location, etc.). Characteristics of the usage session that may be used as criteria include, but are not limited to, types of events, sections of application functionality, and sections of application features.

Using the selected criteria to define an aggregate data set allows graphical representation 110 to be provided for the selected criteria and for different sets of selected criteria that may be assessed for differences in usage. Thus, graphical representation 110 may display a shared path experience for a set of data defined by the selected criteria (e.g., a path shared by a set of users). In some embodiments, multiple aggregate data sets may be compared and contrasted (e.g., using multiple layers in graphical representation as described above). Comparing and contrasting different aggregate data sets may be used to assess usage differences based on the criteria that define the different aggregate data sets (e.g., compare and contrast usage for different user demographics).

Recording usage session data and then generating and displaying graphical representation 110, as described herein, may allow a user to observe and assess usage sessions (including multiple layers of usage sessions simultaneously and/or usage sessions assembled from aggregate data sets) after the usage sessions are completed. Graphical representation 110 may provide the observing user an “in real-time” playback of sequential events from the usage sessions. The observing user may use his/her observation of graphical representation 110 to assess how and why certain events occur during the usage sessions. Additionally, using generated metrics and/or other analysis tools allows the user to scientifically observe, assess, and/or compare usage sessions. These assessment tools may be used to diagnose usability and/or design problems with software application 106 and/or GUI environment 104 as well as potentially assess attempts to address any uncovered problems.

Additionally, there are technical programming advantages to allowing data recording module 102 to drive operation of software application 106 in association with generating graphical presentation 110. A tree path technology may be created that allows a user to store and/or find objects in a DOM (Document Object Model) tree path (e.g., an objects tree path) after a page (e.g., a web page) is re-created. The objects tree path may be used to create a responsive and layout independent map. The objects tree path may also allow fast object relations checking (e.g., parent to children) without the need for object tree traversing. Additional programming may include event handler assessment and/or event catching on targets with disabled event propagation and/or prevented default action. Programming may also include JavaScript simulation of CSS (Cascading Style Sheets) hover style mutations.

In certain embodiments, one or more process steps described herein may be performed by one or more processors (e.g., a computer processor) executing instructions stored on a non-transitory computer-readable medium. For example, data recording module 102, shown in FIGS. 1 and 5, may have one or more steps performed by one or more processors executing instructions stored as program instructions in a computer readable storage medium (e.g., a non-transitory computer readable storage medium). In certain embodiments, data recording module 102, GUI environment 104, software application 106, and database 108 include program instructions in the computer readable storage medium.

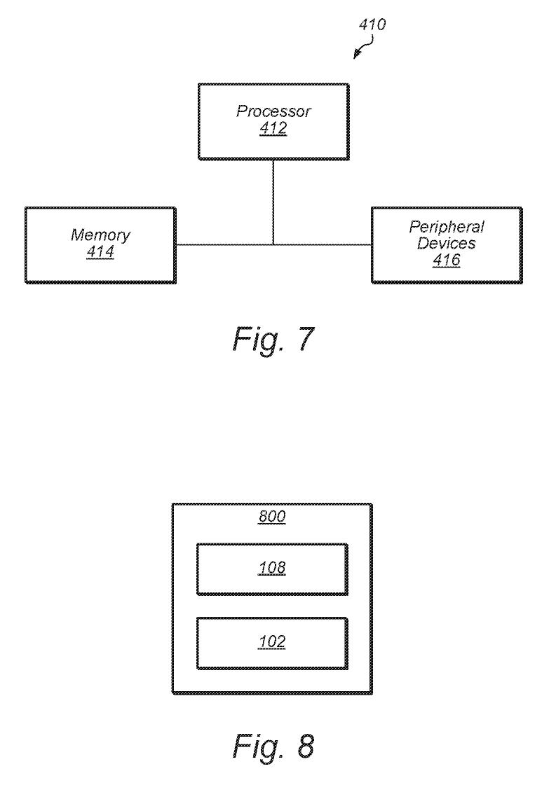

FIG. 7 depicts a block diagram of one embodiment of exemplary computer system 410. Exemplary computer system 410 may be used to implement one or more embodiments described herein. In some embodiments, computer system 410 is operable by a user to implement one or more embodiments described herein such as data recording using data recording module 102, FIGS. 1 and 5. In the embodiment of FIG. 7, computer system 410 includes processor 412, memory 414, and various peripheral devices 416. Processor 412 is coupled to memory 414 and peripheral devices 416. Processor 412 is configured to execute instructions, including the instructions for data recording by data recording module 102, which may be in software. In various embodiments, processor 412 may implement any desired instruction set (e.g. Intel Sparc, MIPS, ARM, IA-64, etc.). In some embodiments, computer system 410 may include more than one processor. Moreover, processor 412 may include one or more processors or one or more processor cores.

Processor 412 may be coupled to memory 414 and peripheral devices 416 in any desired fashion. For example, in some embodiments, processor 412 may be coupled to memory 414 and/or peripheral devices 416 via various interconnect. Alternatively or in addition, one or more bridge chips may be used to coupled processor 412, memory 414, and peripheral devices 416.

Memory 414 may comprise any type of memory system. For example, memory 414 may comprise DRAM, and more particularly double data rate (DDR) SDRAM, RDRAM, etc. A memory controller may be included to interface to memory 414, and/or processor 412 may include a memory controller. Memory 414 may store the instructions to be executed by processor 412 during use, data to be operated upon by the processor during use, etc.

Peripheral devices 416 may represent any sort of hardware devices that may be included in computer system 410 or coupled thereto (e.g., storage devices, optionally including computer accessible storage medium 800, shown in FIG. 8, other input/output (I/O) devices such as video hardware, audio hardware, user interface devices, networking hardware, etc.).

Turning now to FIG. 8, a block diagram of one embodiment of computer accessible storage medium 800 including one or more data structures representative of recorded data in database 108 (depicted in FIGS. 1 and 5) and one or more code sequences representative of data recording by data recording module 102 (shown in FIGS. 1 and 5). Each code sequence may include one or more instructions, which when executed by a processor in a computer, implement the operations described for the corresponding code sequence. Generally speaking, a computer accessible storage medium may include any storage media accessible by a computer during use to provide instructions and/or data to the computer. For example, a computer accessible storage medium may include non-transitory storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, computer accessible storage medium 800 may store data in a non-transitory manner, where non-transitory in this context may refer to not transmitting the instructions/data on a signal. For example, non-transitory storage may be volatile (and may lose the stored instructions/data in response to a power down) or non-volatile.

Embodiments of the present disclosure may be realized in any of various forms. For example some embodiments may be realized as a computer-implemented method, a computer-readable memory medium, or a computer system. In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. A method, comprising:
recording, using a computer processor, data of a plurality of interactions with a graphical user interface (GUI) environment by a user as the user executes one or more operations in the GUI environment, at least one of the interactions comprising movement between at least two sequential input events in the GUI environment caused by the user;
generating, using the computer processor, a graphical representation of the recorded data of the plurality of interactions, the graphical representation comprising the movement between the at least two sequential input events caused by the user; and
displaying, on a display coupled to the computer processor, the graphical representation in combination with the GUI environment.

2. The method of claim 1, wherein displaying the graphical representation in combination with the GUI environment comprises overlaying the graphical representation on the GUI environment such that the recorded data of the plurality of interactions is displayed in the GUI environment.

3. The method of claim 1, wherein recording the data of the plurality of interactions comprises recording interactions as a function of time.

4. The method of claim 1, wherein at least one of the interactions comprises movement of an indicator between at least two sequential input events in the GUI environment caused by the user.

5. The method of claim 4, wherein the graphical representation comprises the movement of the indicator between the at least two sequential input events caused by the user.

6. The method of claim 1, wherein the graphical representation comprises a map displayed in the GUI environment that depicts sequential movement between two or more input events caused by the user.

7. The method of claim 6, wherein the graphical representation comprises a linear display of a timeline of the movement between the input events caused by the user.

8. The method of claim 7, wherein selection of an input event on the linear display of the timeline moves an indicator associated with the map to an input event displayed on the map corresponding to the selected input event.

9. The method of claim 1, further comprising:
recording, using the computer processor, data of a plurality of interactions with a graphical user interface (GUI) environment by an additional user as the additional user executes one or more operations in the GUI environment, at least one of the interactions comprising movement between at least two sequential input events in the GUI environment caused by the additional user;
generating, using the computer processor, an additional graphical representation of the recorded data of the plurality of interactions, the graphical representation comprising the movement between the at least two sequential input events caused by the additional user; and
displaying, on the display coupled to the computer processor, the additional graphical representation in combination with graphical representation and the GUI environment.

10. A method, comprising:
providing, using a computer processor, a plurality of operations to be executed by a plurality of users in a graphical user interface (GUI) environment;
recording, using the computer processor, data of a plurality of interactions with the GUI environment by each user as the user executes one or more operations in the GUI environment, at least one of the interactions comprising movement between at least two sequential input events in the GUI environment, the movement being in response to input by the user;
combining, using the computer processor, the recorded data of the plurality of interactions for at least two users;
generating, using the computer processor, a graphical representation of the combined data, the graphical representation comprising sequential movement between at least two input events based on the combined data; and
displaying, on a display coupled to the computer processor, the graphical representation in combination with the GUI environment.

11. The method of claim 10, further comprising using the combined data to operate a software application associated with the GUI environment.

12. The method of claim 11, wherein generating the graphical representation comprises operating the software application with the combined data to generate the graphical representation.

13. The method of claim 12, wherein displaying the graphical representation in combination with the GUI environment comprises overlaying the graphical representation on the GUI environment such that movement between input events displayed in the GUI environment represent movement between input events generated by the software application during generation of the graphical representation.

14. The method of claim 10, wherein the graphical representation comprises a map displayed in the GUI environment that depicts sequential movement between two or more input events.

15. The method of claim 10, wherein the graphical representation comprises a linear display of a timeline of the movement between the input events.

16. The method of claim 10, further comprising assessing the display of the graphical representation in combination with the GUI environment to determine one or more characteristics of a user experience associated with the GUI environment.

17. A non-transient computer-readable medium including instructions that, when executed by one or more processors, causes the one or more processors to perform a method, comprising:
recording, using a computer processor, data of a plurality of interactions with a graphical user interface (GUI) environment by a user as the user executes one or more operations in the GUI environment, at least one of the interactions comprising movement between at least two sequential input events in the GUI environment caused by the user;
generating, using the computer processor, a graphical representation of the recorded data of the plurality of interactions, the graphical representation comprising the movement between the at least two sequential input events caused by the user; and
displaying, on a display coupled to the computer processor, the graphical representation in combination with the GUI environment.

18. The non-transient computer-readable medium of claim 17, further comprising providing, using the computer processor, a plurality of predefined operations to be executed by the user in the GUI environment.

19. The non-transient computer-readable medium of claim 17, wherein the movement between the at least two sequential input events in the GUI environment comprises movement of an indicator used in GUI environment that identifies a selected position in the GUI environment that will be affected by input from the user.

20. The non-transient computer-readable medium of claim 17, wherein at least one input event comprises an action by the user that directs a software application associated with the GUI environment to operate in response to the action by the user.
